(19) United States
(12) Patent Application Publication
(10) Pub. No.: US 2008/0085764 A1
(43) Pub. Date: Apr. 10, 2008

(54) PROGRESSIVE GAMING SYSTEM AND METHOD OF USE

(76) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(21) Appl. No.: 11/831,820

(22) Filed: Jul. 31, 2007

Related U.S. Application Data
(60) Provisional application No. 60/820,941, filed on Jul. 31, 2006.

(51) Int. Cl. G06F 19/00; A63F 9/24

(52) U.S. Cl. 463/27

(57) ABSTRACT

A progressive gaming system includes a gaming device and a non-gaming device. A controller is in communication with the gaming device and the non-gaming device. The controller is configured to receive a first wager from the gaming device, play a first game on the gaming device and apportion a first percentage of the first wager to a progressive jackpot. The controller further can award a first prize on the gaming device, receive a second wager through the non-gaming device and play a second game. The outcome of the second game is communicated to the non-gaming device. The controller may apportion a second percentage of the second wager to the progressive jackpot, award a second prize and communicate the award of the second prize to the non-gaming device. In addition, the controller determines if a progressive jackpot-winning event has occurred for either the gaming device or the non-gaming device, communicates the occurrence of the progressive jackpot-winning event, and awards a progressive jackpot.

### FIELD OF THE INVENTION

The present invention relates to gaming devices and, more particularly, to a gaming system that allows for gaming and non-gaining devices to play for a progressive jackpot.

### BACKGROUND

Gaming devices are well known in the art and a large variety of gaming devices have been developed. In general, gaming devices allow users or players to play a game, in many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes m addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that they player deems to be unattractive.

One way gaming device manufactures have added additional enjoyment and excitement to gaming devices is through the advent of progressive gaming. Progressive games have become very popular in casinos. Progressive slot machines contain jackpots that increase every time a player places a wager in a primary game of the slot machine. Progressive jackpots involve one or more gaming machines. For example, an individual progressive slot machine has a self-contained jackpot, wherein the jackpot grows with every play of that machine. A linked progressive includes two or more slot machines at the same or different locations connected to a common jackpot, with each machine individually contributing to the common jackpot.

The gaming machines may be linked and controlled by a conventional computer communication system such as local or wide area networks. The gaming machines usually take a percentage of the player's wager, such as 2%, and add it to the progressive jackpot. This allows the progressive jackpot to grow over time. The progressive jackpot can reach a sizeable amount, such as a multi-million dollar jackpot, before a player “hits” or wins the progressive jackpot.

Large progressive jackpots can be very attractive to casino game players. Furthermore, as the progressive jackpot grows, so does the game's payout percentage because the game pays out more while the likelihood of receiving the progressive award or jackpot remains constant. Players looking to inject skill or strategy into a gaming event therefore look to find progressive games having relatively high progressive jackpots, i.e., games that have not recently paid out.

In order to provide larger attractive progressive jackpots, gaming establishments need to attract as many game players as possible. The more game players that can play on a linked progressive jackpot system, the larger the possible progressive jackpot.

Game players frequently travel long distances to visit gaming establishment centers in cities such as Las Vegas and Atlantic City. Eventually the game players must return to their residences. Often the game players desire to continue the gaming experience that they had on vacation. Game players also desire to be able to play casino games at their convenience. Game players desire to be able to play casino games when and where they choose.

What is needed is a progressive gaming system that allows more game players to play for a progressive jackpot from a remote location.

### SUMMARY OF ONE EMBODIMENT OF THE INVENTION

Advantages of One or More Embodiments of the Present invention

The various embodiments of the present invention may, but do not necessarily, achieve one or more of the following advantages:

the ability to provide game players with a more exciting and desirable gaming experience;

the ability to attract more patrons to play a game;

provide longer play times and a greater payout possibility for a player;

provide greater revenues for gaming operators;

provide a gaming device that can award larger progressive jackpots to more players more frequently.

provide a non-gaming device that can be used to play casino games remotely from a gaming establishment;

provide a communication device that can link a game player to a remote progressive game.

provide a progressive gaming system that allows gaming and non-gaming devices to play and win a progressive jackpot;

provide a server that can connect gaming and non-gaming devices;

provide software that can operate on a server to communicate with various communication devices and gaming machines to administer a progressive jackpot game; and

provide a gaming system that can fund a progressive jackpot from gaming devices and from remote non-gaming devices.

These and other advantages may be realized by reference to the remaining portions of the specification, claims, and abstract.

### BRIEF DESCRIPTION OF ONE EMBODIMENT OF THE PRESENT INVENTION

In certain embodiments, the present, invention relates to a gaming apparatus that includes a gaming device and a communication device. A controller is in communication with the gaming device and the communication device. The controller is configured to receive a first wager from the gaming device, enable a first game to be played on the gaming device and apportion a first percentage of the first wager to a progressive jackpot. The controller further can award a first prize on the gaming device, receive a second wager through the communication device and play a second game. The outcome of the second game is communicated to the communication device. The controller apportions a second percentage of the second wager to the progressive jackpot, awards a second prize and communicates the award of the second prize to the communication device. In addition, the controller determines if a progressive jackpot-winning event has occurred for either the gaming device or the communication device, communicates the occurrence of the progressive jackpot-winning event and awards a progressive jackpot.

In other embodiments, the present invention relates to a gaming method. According to the method, a first wager is received from a gaming device and a first game is played on the gaming device. A first percentage of the first wager is apportioned to a progressive jackpot. A first prize is awarded on the gaming device. A second wager is received through a communication device. A second game is played on a server. The outcome of the second game is communicated to the communication device. A second percentage of the second wager is apportioned to the progressive jackpot. A second prize is awarded and the the award of the second prize is communicated to the communication device. It is determined if a progressive jackpot-winning event has occurred for either the gaming device or the communication device. The occurrence of the progressive jackpot-winning event is communicated, if the progressive jackpot-winning event has occurred. A progressive jackpot is awarded.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components as set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a diagrammatic view of a progressive gaming system using gaming and non-gaming devices in accordance with the present invention.

FIG. 2 is substantially a front view of a gaming device of the present invention.

FIG. 3 is substantially a schematic diagram of a portion of the gaming device of FIG. 2.

FIG. 4 is substantially a front view of a personal computer in communication with a progressive gaming system.

FIG. 5 is substantially a front view of a mobile phone in communication with a progressive gaming system.

FIG. 6 is substantially a flowchart of a gaming method of the present invention.

FIG. 7 is substantially a flowchart of another gaming method of the present invention.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced, it is to be understood that other embodiments maybe utilized and structural changes may be made without departing from the scope of the present invention.

Progressive Gaming System

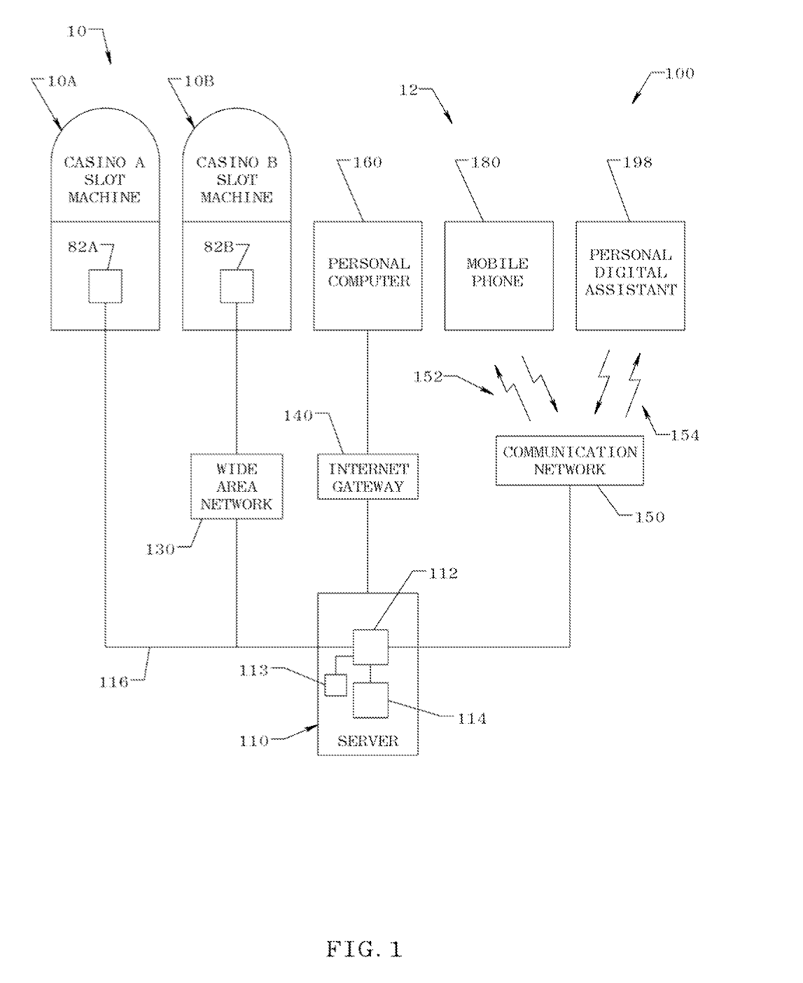

Referring to FIG. 1, one embodiment disclosed herein comprises a progressive gaining system, generally indicated by reference number 100. Progressive gaming system 100 comprises a computer server 110 that is in communication with several gaming apparatuses or devices 10 and several communication or non-gaming devices 12. Progressive gaming system 100 can accept wagers from multiple gaming devices 10 and communication or non-gaming devices 12 and administer one or more games that allow a player to play for a progressive jackpot.

Progressive gaming system 100 can include several gaming devices such as gaming devices 10A and 10B. Gaming device 10A can be located in casino A (not shown) and gaming device 10B can be located in casino B (not shown). Casinos A and B may be located nearby or may be located in a remote area a long distance from each other. For example, casino A may be in Las Vegas, Nev. and casino B may be in Atlantic City, N.J. While two gaming devices are shown, more or less can be used. Gaming device 10A has a controller 82A that at least partially controls the operation of the gaming device. Gaming device 10B has a controller 82B that at least partially controls the operation of the gaming device.

Gaming device 10A may be in communication with a computer network server 110 through a local area network (LAN) data transmission cable 116 such as an Ethernet cable. One or more gaming devices 10A are in communication with a server 110. While a single device 10A is shown, any number of gaming devices 10A may be connected with server 110. The server 110 may be any suitable server or computing device which Includes at least one processor 112 and a memory or storage device 114. Processor 112 can be a conventional micro-processor and storage device 114 may be random access memory or hard disk, drives. Software can be stored on storage device 114 and operate on processor 112 in order to implement progressive gaming system 100. Server 110 can also contain a random number generator 113 that is in communication with processor 112. Random number generator 113 is capable of generating a random number. Processor 112 of server 110 may be in communication with controller 82A of gaming device 10A.

In one embodiment, storage device 114 of server 110 stores different game software programs and instructions that are executable by processor 112 to control gaming device 10A. Each executable game program represents a different game or type of game which may be played on one or more of the gaming devices in the gaming system. Such different games may include the same or substantially the same game play with different pay tables. In different embodiments, the executable game program is for a primary game, a secondary game or both, in another embodiment, the game program may be executable as a primary game that is downloaded from server 110 to gaming device 10A.

Server 110 can collect and transmit game information and instructions between server 110 and gaming device 10A. For example, server 110 can apportion a percentage of each wager placed on gaming device 10A to fund a progressive jackpot.

Because gaming devices 10 and non-gaming devices 12 may be receiving different amounts of wagers at any one time, server 110 may be programmed to adjust the odds of winning the progressive jackpot depending upon the amount wagered. For example, a player at one gaming device wagering $10.00 would have twice the probability of winning the progressive jackpot as a game player wagering $5.00. In another embodiment, server 110 may require all wagers to have the same monetary amount.

In an embodiment, server 110 may be programmed to adjust the odds of winning the progressive jackpot using the following formulas:

SB×SPC×1/SPR=SEV
Where
SB=Standard Bet
SPC=Standard progressive contribution
SPR=Standard probability of Top award
SEV=Standard Event Value

The standard event value (SEV) used to equalize the probability of winning the progressive jackpot based upon the amount wagered. The value of SEV is calculated for each wager that is placed.

EBV×EPC×1/EPR=SEV
Where
EBV=Event Bet Value
EPC=Event Progressive contribution
EPR=Event probability of Top Award

This formula is used to calculate the event progressive contribution (EPC) for wagers of different amounts. These wagers may be on the same type of game device or a non-gaming device.

For example, assume that the standard bet is $10.00 dollars and the standard progressive contribution is 1% or 10 cents and the standard probability of winning the progressive jackpot is 1 in 1 million, then:
SB=10
SPC=0.01
SPR=0.000001

Standard Event Value (SEV)=(10)(0.01)(1/0.000001)=100,000

Next, assume that a non gaming device requires a $5.00 dollar bet and a gaming device requires a $10.00 dollar bet. Using the formula EPC=SEV/(EBV×1/EPR), the value of EPC or event progressive contribution can be calculated as follows;

EPC=100,000/(5)(1/0.000001)−0.02=2%

### Therefore, the event progressive contribution for a $5.00 dollar wager on a non-gaming device would be 2 percent of $5.00 dollars or 10 cents.

The event progressive contribution for a $10.00 dollar wager on a gaming device would be calculated as follows:

EPC=100,000/(10)(1/0.000003)=0.01−1%

Therefore, the event progressive contribution for a $10.00 dollar wager on a gaming device would be 1 percent of $10.00 dollars or 10 cents.

Gaming device 10B may be in remote communication with server 110 through a data network such as a wide area network (WAN) 130. Wide area network 130 may be a conventional high speed wide area network that uses commercial data transmission networks.

In one embodiment, the data network is a wide area network in which one or more of the gaming devices 10B are in communication with at least one off-site server 110. In this embodiment, the plurality of gaming devices 10B may be located in a different part of the gaming establishment or within a different casino in another location. The wide area network may include an off-site server 110 and an off-site gaming device 10B located within gaming establishments in the same geographic area, such as a city or state.

Gaming devices 10B connected to wide area network 130 may operate in substantially the same manner as gaming devices 10A connected to server 110.

Progressive gaming system 100 can further include several communication devices or non-gaming devices 12. Non-gaming devices 12 can include a personal computer 160, mobile phone 180 and personal digital assistant (PDA) 198. Non-gaming device 12 can be any suitable device that does not perform a game function. For example, non-gaming devices 12 may include automobiles, refrigerators, stoves, radios, televisions, calculators, telephones, answering machines, CD and MP3 players, portable computers and GPS receivers. Non-gaming devices 12 may also include devices that are located at a game but are not part of the game. For example, non-gaming device 12 may be an electronic device that is mounted at a card table game such as blackjack. In this example, non-gaming device 12 may allow a blackjack player to place an additional wager to have a chance to win a progressive jackpot.

Personal computer 160 may be in communication with server 110 through an internet gateway 140. A game can be initiated by a player through personal computer 160 that is played on server 110. The game outcome can be communicated from server 110 to personal computer 160 and displayed to the player. Any credits won or lost can be credits to a player's account with the gaming establishment. An account may have to be established and funded with the gaming establishment prior to the start of any gaming activity.

Internet gateway 140 can communicate and transfer data to the internet or an intranet. In this embodiment, any games played through non-gaming devices 12 can be viewed with at least one internet browser. Operation of the non-gaming device 12 and accumulation of credits may be accomplished with only a connection to server 110. Internet gateway 140 can be a conventional phone or other data transmission line, digital subscriber line (DSL), T-1 line, coaxial cable, fiber optic cable, or other suitable connection.

In this embodiment, players may access an internet game page from any location where an internet connection and computer, or other internet facilitator is available. The expansion in the number of computers and number and speed of internet connections in recent years increases opportunities for players to play from an ever-increasing number of remote sites. Communication over internet gateway 140 may be done securely through the use of secure encryption technology such as SSL.

Mobile phone 180 and personal digital assistant (PDA) 198 may be in communication with server 110 through a communication network 150 using wireless signals 152 and 154, respectively. A game can be initiated by a player through mobile phone 180 or PDA 198 that is played on server 110. The game outcome can be communicated from server 110 to mobile phone 180 or PDA 198 and displayed to the player. Any credits won or lost can be credited to a player's account with the gaming establishment. An account may have to be established and funded with the gaming establishment prior to the start of any gaming activity.

Communication network 150 can be any suitable wireless network including digital and analog telephone networks such as CDMA and GSM mobile phone networks. Communication network 150 may use secure encryption technology such as SSL. The enhanced bandwidth and speed of digital wireless communications may be used for enhancing the sophistication and response of the display and interaction with the player.

Progressive gaming system 100 can collect wagers from gaming devices and remotely located non-gaming devices. Progressive gaming system 100 can allocate a percentage of the total wagers received to fund a progressive jackpot. Because progressive gaming system 100 can collect wagers from a larger pool of game players, progressive gaming system 100 can provide for the funding of large progressive jackpots that can attract the interest of game players.

Gaming Device

Referring to FIGS. 1-3, further details of an embodiment of gaming devices 10A and 10B (now referred to as gaming device 10) are shown. Gaming device 10 comprises a primary game apparatus 20 and a progressive jackpot display 50. Game apparatus 20 may be any of a large number of devices that are adapted to allow players to play a game. For example, game apparatus 20 may utilize reel displays, such as spinning reels 22-24 or a video display (not shown), to display outcomes of the game. Means may also be provided for accepting wagers, such as a coin slot 21 or card reader 25, and for awarding prizes, such as a coin dispenser 27. A handle 26 and button 28 are provided for activating game apparatus 20 to begin a game. In at least one embodiment, game apparatus 20 may be an S Plus model gaming device manufactured by International Game Technology in Reno, Nev.

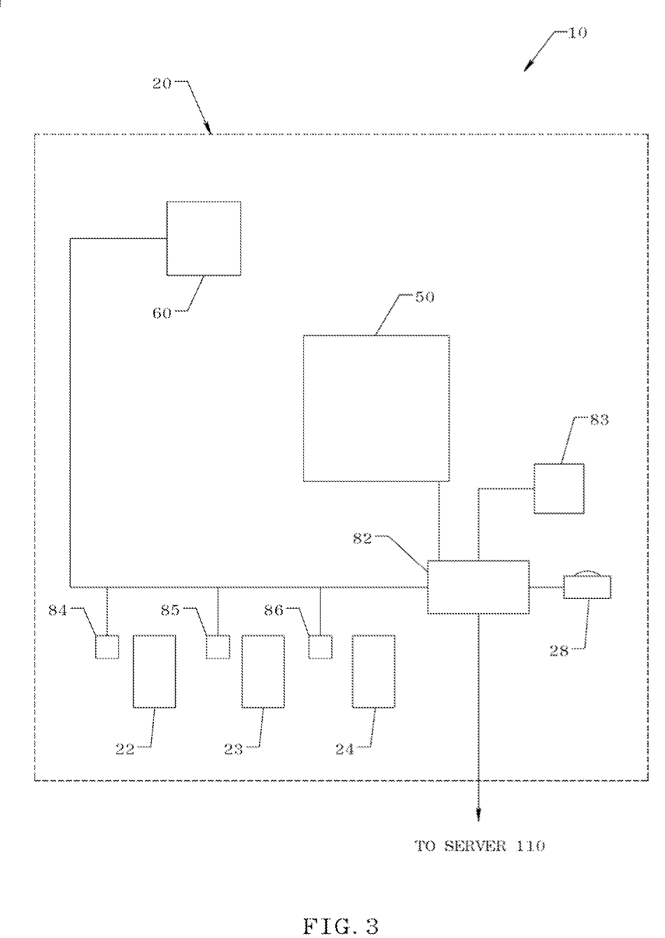

Game apparatus 20 may be controlled by an electronic controller 82 (see FIG. 3) that utilizes a random number generator 83 (FIG. 3). The random number generator produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator. It is recognized that game apparatus 20 may operate in many other ways and still achieve the objects of the present invention.

Game apparatus 20 may also be capable of producing a jackpot qualifying event. This event may be many different types of events. For example, a jackpot qualifying event may comprise displaying a particular symbol, such as a “bonus” symbol, or combination of symbols, such as three “7” symbols, on reels 22-24 as shown in FIG. 1. If the game being played is poker based, the jackpot qualifying event may be occurrence of a certain hand, such as a royal flush. Furthermore, a jackpot qualifying event may occur when a player accumulates a number of symbols or game outcomes over a number of separate game plays. For example, a jackpot qualifying event may occur when the player receives three “jackpot” symbols during a period of time. The jackpot qualifying event maybe based on an external event. For example, a jackpot qualifying event may occur when a group of players obtain a certain result.

Alternatively, server 110 may determine the occurrence of jackpot qualifying event.

Progressive jackpot display 50 may have a housing 32 with a front panel 33. Housing 32 can be made from many different materials such as metal or plastic and can include decorative coverings or attachments and lights. A display such as a credit meter 60 can be used to display prizes won on game apparatus 20 and progressive jackpot display 50.

Progressive jackpot display 50 may be a video display and can be mounted in front panel 33. Progressive jackpot display 50 can be any suitable display including video displays, plasma displays, LCD displays, LED meters and the like. Progressive jackpot display 50 may be a single display or can be more than one display.

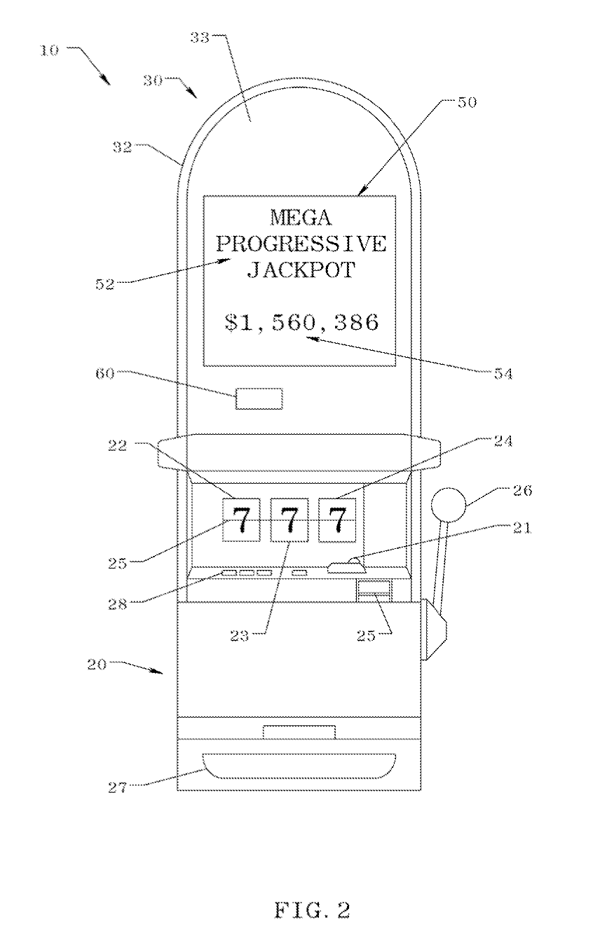

Progressive jackpot display 50 may be activated upon the occurrence of a jackpot qualifying event in primary game apparatus 20 or may be activated by server 110. As seen in FIG. 2, progressive jackpot display 50 is shown displaying a progressive jackpot. The title or name 52 of the progressive jackpot is “Mega Progressive Jackpot”. Progressive jackpot display 50 can show indicia 54 that convey the value or amount of a progressive prize to be awarded to a player. As shown in FIG. 2, the progressive jackpot has a value of $1,560,386. Indicia 54 can be a wide variety of awards, such as trips, vouchers, gaming credits, comps for meals or hotels or monetary awards. A game player playing gaming device 10 may be awarded the progressive jackpot.

Server 110 and controller 82 can determine the size of the progressive jackpot, determine the amount and method of funding of the progressive jackpot and can cause display 50 to display the current value of progressive jackpot using indicia 54.

Server 110 and controller 82 are adapted to detect when a jackpot qualifying event occurs in game apparatus 20. This may be accomplished by game apparatus controller 82 transmitting a signal to server 110 that a jackpot qualifying event has occurred, or by server 110 transmitting a signal to controller 82. For example, controller 82 may determine the outcome of each game and when a jackpot qualifying event outcome occurs, it transmits a signal to server 110.

In another embodiment, one or more sensors may be provided for determining if a jackpot qualifying event has occurred. For example, sensors 84-86 may sense the positions of reels 22-24. When reels 22-24 are in a position that activates a jackpot qualifying event, controller 82 would sense this position and begin a progressive award sequence.

Controller 82 may also transmit a variety of information to server 110. For example, controller 82 may signal when coins or currency have been inserted, when a game starts, when an error has occurred, and when a sensor detects tampering.

When server 110 determines that a jackpot qualifying event has occurred, it may begin a jackpot award sequence using progressive jackpot display 50. Progressive jackpot display 50 may indicate that a player has won the progressive jackpot.

Server 110 can determine if a progressive jackpot qualifying event has occurred using random number generator 113. Random number generator 113 generates a random number and supplies the random number to processor 112. Processor 112 compares the random number to a pay table similar to that described in U.S. Pat. No. 5,823,874, issued to Adams. A simple pay table may appear as follows:

TABLE 1

| Random Number | Award |
|---|---|
| 0.00 to 0.99999999999999 | No Award |
| 1.00 | Progressive Jackpot |

For example, if the random number generator produced 0.64, progressive jackpot would not be awarded. If the random number generator produced 1.00, the progressive jackpot would be indicated as being won and the award amount shown on progressive jackpot display 50 would be awarded to the player. This embodiment is not necessarily limited to the example pay table shown. A larger or less number of progressive jackpots maybe used. Furthermore, different kinds of prizes may be awarded along with a progressive jackpot. For example, a progressive jackpot and a vacation could be awarded or a progressive jackpot and an award to play additional games could be awarded.

Non-Gaming Devices

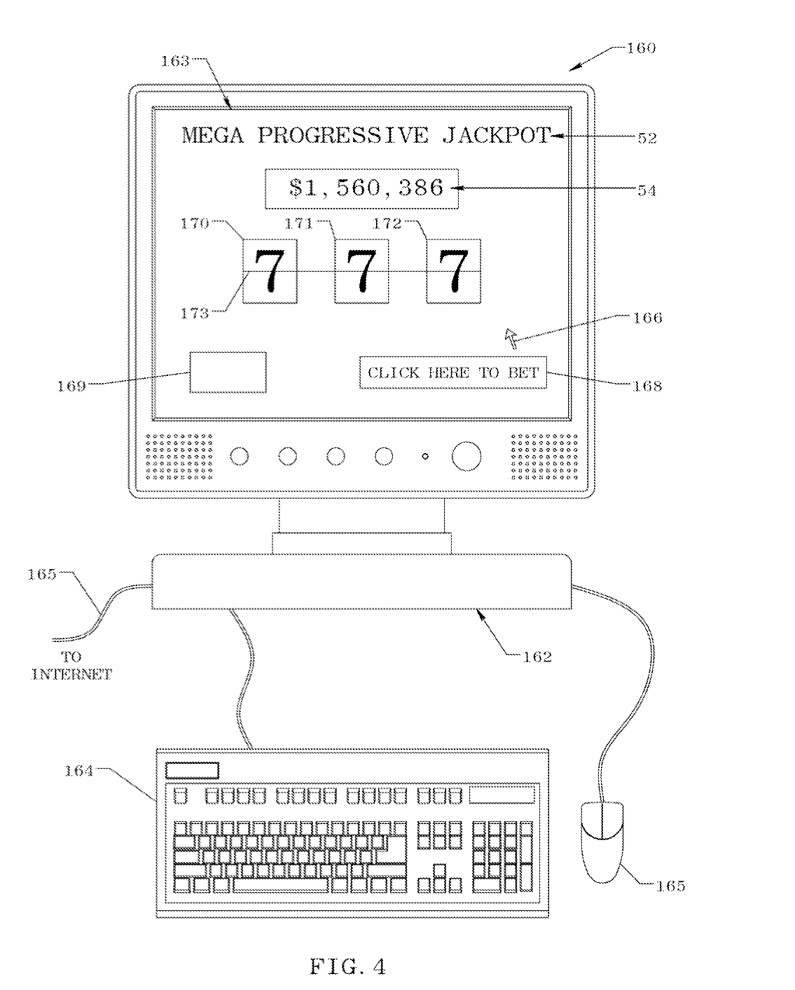

Referring to FIG. 4, further details of personal computer 160 are shown. Personal computer 160 comprises a central processing unit or CPU 162, a display 163, keyboard 164, mouse 165 and cursor 166. Personal computer 160 can be connected to internet gateway 140 (FIG. 1) through a cable 165 such as an Ethernet cable in order to be in communication with server 110 (FIG. 1).

A game can be initiated by a player through personal computer 160 that is played on server 110. The game outcome can be communicated from server 110 to personal computer 160 and displayed to the player. Any credits won or lost can be credited or debited to a player's account with the gaming establishment. An account may have to be established and funded with the gaming establishment prior to the start of any gaming activity,

FIG. 4 shows one possible game display on display 163. Display 163 can be any suitable display such as an LCD video display. Display 163 is shown having a game title 52, progressive award indicia 54, reel displays 170, 171 and 172, payline 173, credit meter 169 and click-to-bet button 168.

In this embodiment, a player may log into server 110 (FIG. 1) and access a pre-established account, in order to place wagers and play a game. Server 110 can determine the outcome of the game and personal computer 160 may communicate the outcome of the game using reel displays 170, 171 and 172. Any credits won or lost can be shown on credit meter 169.

Server 110 can allocate a portion of the wager from the player's account to fund a progressive jackpot indicated by indicia 54. Server 110 can also determine if a progressive jackpot qualifying event has occurred for personal computer 160 and communicate the occurrence of a progressive jackpot win using display 163.

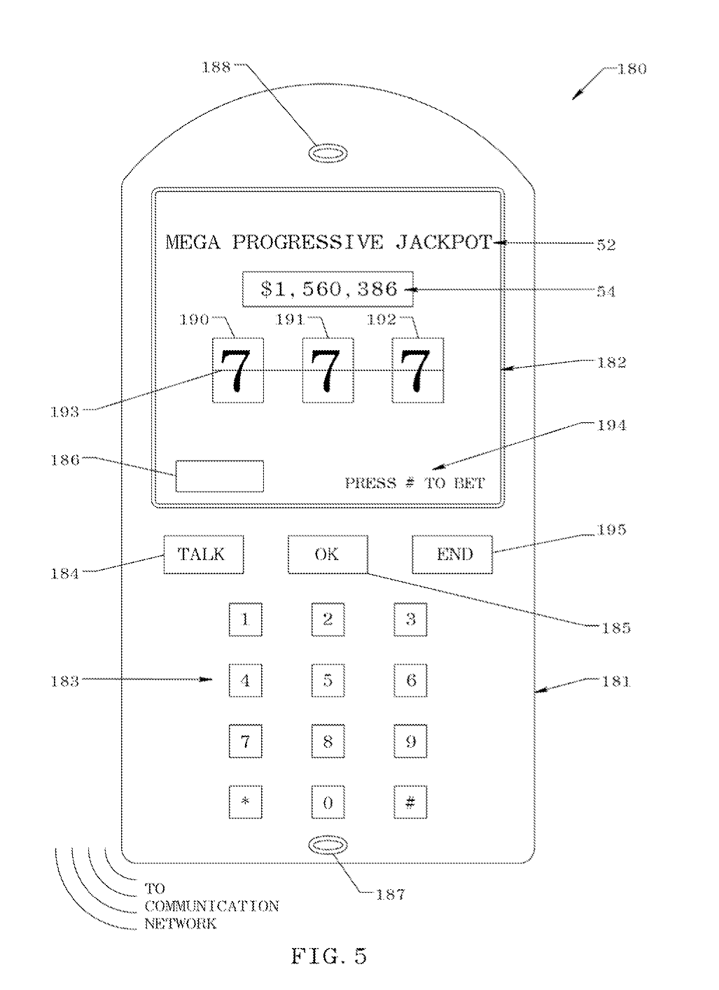

Referring to FIG. 5, further details of mobile phone 180 are shown. Mobile phone 180 comprises a housing 181, keypad 183, display 182, talk button 184, OK button 185, end button 195, speaker 188, and microphone 187.

Mobile phone 180 can be in wireless communication with a communication network 150 (FIG. 1) in order to be in communication with server 110. A game can be initiated by a player through mobile phone 180 that is played on server 110. The game outcome can be communicated from server 110 to mobile phone 180 and displayed to the player. Any credits won or lost can be credited or debited to a player's account with the gaming establishment. An account may have to be established and funded with the gaming establishment prior to the start of any gaming activity.

FIG. 5 shows one possible game display on display 182. Display 182 can be any suitable display such as an LCD video display. Display 182 is shown having a game title 52, progressive award indicia 54, reel displays 190, 191 and 192, payline 193, credit meter 186 and bet instruction 194.

In this embodiment, a player may access server 110 (FIG. 1) using mobile phone 180 and access a pre-established account in order to place wagers and play a game. Server 110 can determine the outcome of the game and mobile phone 180 may communicate the outcome of the game using reel displays 190, 191 and 192. Any credits won or lost can be shown on credit meter 186.

Server 110 can allocate a portion of the wager from the player's account to fund a progressive jackpot indicated by indicia 54. Server 110 can also determine if a progressive jackpot qualifying event has occurred for mobile phone 180 and communicate the occurrence of a progressive jackpot win using display 182.

A game can also be played using on personal digital assistant 198 (FIG. 1) with server 110 in the same manner as was shown using mobile phone 180.

Game Play Flow Chart For Gaming Devices

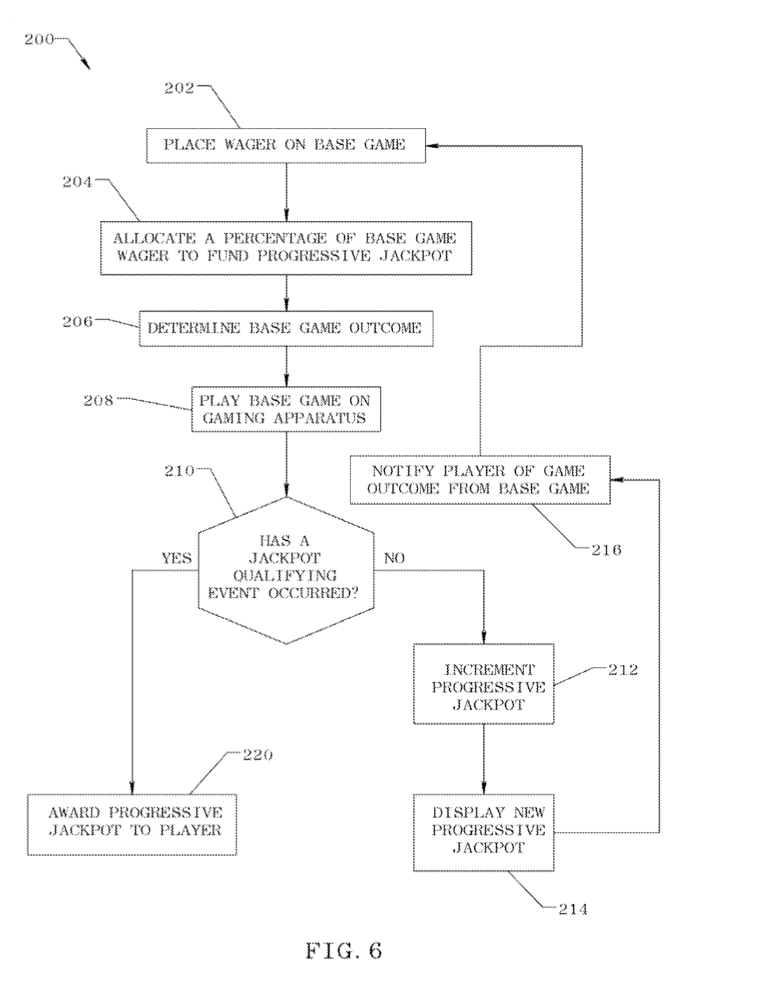

Referring now to FIGS. 1 and 6, a flowchart of a method of game play 200 using progressive gaming system 100 is shown. At step 202, a player may initiate game play method 200 by placing a wager one of gaming devices 10. The wager may be in form of cash or credit from actual domestic or foreign currency, vouchers, coupons, tickets, electronic cards, and other sources or forms of wagers known in the art. At step 204, server 110 may allocate a percentage of the wager such as 2% to fund a progressive jackpot. Once the player initiates game play 200, server 110 may generate a random number and randomly determine the base game outcome at step 206. Next, the player may play abase of primary game on the gaming device at step 208.

At decision 210, server 110 determines if a jackpot qualifying event has occurred. Server 110 may be programmed to accomplish this by generating another random number and comparing the random number to a table of outcomes. If the server does not detect a jackpot qualifying event, method 200 proceeds to step 212 where the progressive jackpot is incremented. The new progressive jackpot is displayed to the player in step 214. The player is notified of the game outcome from the base game at step 216. Method 200 returns to step 202 where the player may place another wager and play again.

If the controller detects a jackpot qualifying event at decision 210, method 200 proceeds to step 220 where the progressive jackpot is awarded.

The steps shown in the flowchart do not necessarily imply that the steps have to take place in a particular order. The order of steps may be varied; some steps may be eliminated; and, some steps may be replaced with other steps. Such variations still fall within the scope of the invention.

Game Play Flow Chart for Non-Gaming Devices

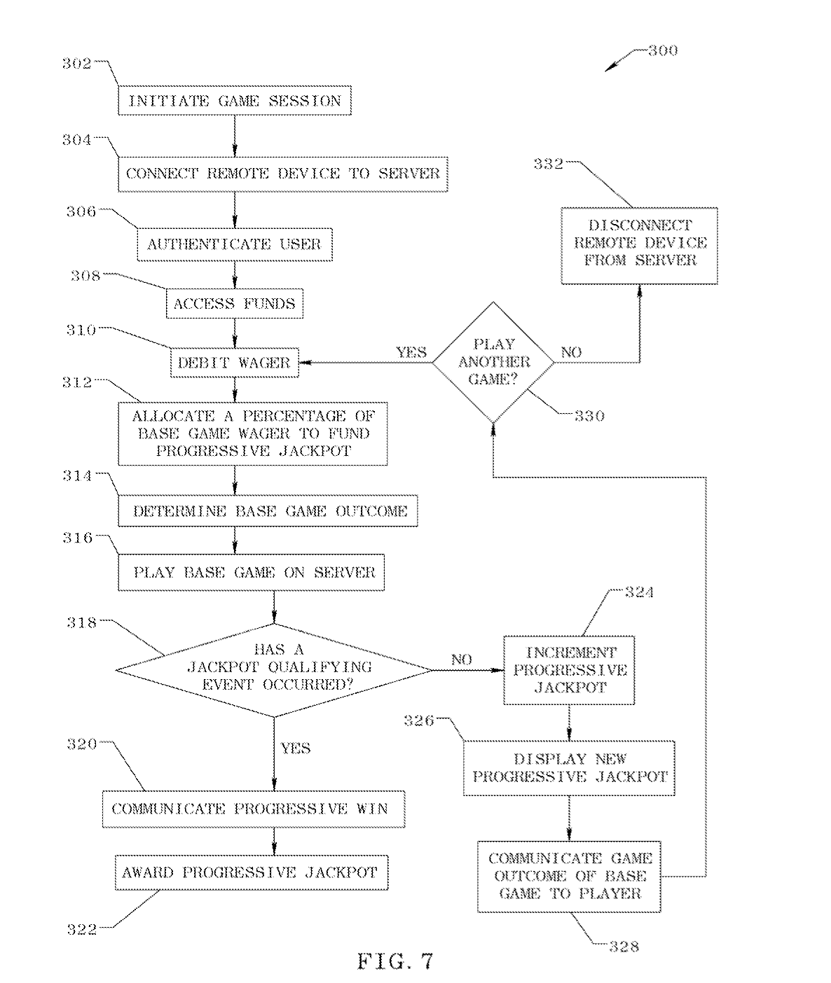

Referring now to FIGS. 1 and 7, a flowchart of a method of game play 300 using progressive gaming system 100 is shown. At step 302, a player may initiate game play method 300 by placing a wager on one of non-gaming devices 12. The wager may be in credits from a pre-established account or other forms of wagers known in the art.

At step 304, the non-gaming device 12 remotely connects to server 110. At step 306, server 110 authenticates the non-gaming device 12 to play a game and at step 308 accesses the player's foods in an account a step 308. Any wagers are debited from the player's account at step 310.

At step 312, server 110 may allocate a percentage of the wager such as 2% to fund a progressive jackpot. Once the player initiates game play method 300, server 110 may generate a random number and randomly determine the base game outcome at step 314. Next, the player may play a base or primary game on the non-gaming device at step 316.

At decision 318, server 110 determines if a jackpot qualifying event has occurred. Server 110 may be programmed to accomplish this by generating another random number and comparing the random number to a table of outcomes. If the server does not detect a jackpot qualifying event, method 300 proceeds to step 324 where the progressive jackpot is incremented. The new progressive jackpot is displayed to the player in step 326. The player is notified, of the game outcome from the base game at step 328. Method 300 then proceeds to decision 330 where the player may place another wager and play again. If the player elects to play another game at decision 330, method 300 returns to step 310. If the player elects to not play another game at decision 330, method 300 proceeds to step 332 where the non-gaming device is disconnected from server 110.

If a jackpot qualifying event occurs at decision 318, method 300 proceeds to step 320 where the progressive jackpot is communicated to the player and awarded in step 322.

The steps shown in the flowchart do not necessarily imply that the steps have to take place in a particular order. The order of steps may be varied; some steps may be eliminated; and, some steps may be replaced with other steps. Such variations still fall within the scope of the invention.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming apparatus comprising:
(A) a gaming device:
(B) a communication device;
(C) a controller in communication with the gaming device and the communication device, the controller being configured to:
(a) receive a first wager from the gaming device;
(b) play a first game on the gaming device;
(c) apportion a first percentage of the first wager to a progressive jackpot:
(d) award a first prize on the gaming device;
(e) receive a second wager through the communication device;
(f) play a second game;
(g) communicate the outcome of the second game to the communication device;
(h) apportion a second percentage of the second wager to the progressive jackpot;
(i) award a second prize;
(j) communicate the award of the second prize to the communication device;
(k) determine if a progressive jackpot-winning event has occurred for either the gaming device or the communication device;
(l) communicate the occurrence of the progressive jackpot-winning event, if the progressive jackpot-winning event has occurred;
(m) award a progressive jackpot.

2. The gaming apparatus of claim 1, wherein the communication device is a computer.

3. The gaming apparatus of claim 1, wherein the communication device is a mobile telephone.

4. The gaming apparatus of claim 1, wherein the communication device is a portable music player.

5. The gaming apparatus of claim 1, wherein the communication device is a portable digital assistant.

6. The gaming apparatus of claim 1, wherein the communication device is in communication with the controller through the internet.

7. The gaming apparatus of claim 1, wherein the communication device is in communication with the controller through a wide area network.

8. The gaming apparatus of claim 1, wherein the gaming device is located in a casino.

9. The gaming apparatus of claim 1, wherein the communication device is not located in a casino.

10. A method of gaming comprising:
(A) receiving a first wager from a gaming device;
(B) playing a first game on the gaming device;
(C) apportioning a first percentage of the first wager to a progressive jackpot;
(D) awarding a first prize on the gaming device;
(E) receiving a second wager through a communication device;
(F) playing a second game on a server;
(G) communicating the outcome of the second game to the communication device:
(H) apportioning a second percentage of the second wager to the progressive jackpot;
(I) awarding a second prize;
(J) communicating the award of the second prize to the communication device;
(K) determining if a progressive jackpot-winning event has occurred for either the gaming device or the communication device;
(L) communicating the occurrence of the progressive jackpot-winning event, if the progressive jackpot-winning event has occurred; and
(M) awarding a progressive jackpot.

11. The method of claim 10, further comprising programming the server with software to perform the method.

12. The method of claim 10, wherein the communication device is selected from the group consisting of:
(A) computer;
(B) mobile telephone;
(C) portable music player;
(D) personal digital assistant.

13. A gaming apparatus comprising:
(A) a plurality of gaming device means for allowing players to place a wager and play a game, the gaming device means in communication with a server;
(B) a plurality of non-gaming device means for allowing players to play a game on the server, the non-gaming device means in communication with the server, the server being adapted to accept a wager and to play the game;
(C) funding means for funding at least one progressive jackpot, the funding means being adapted to apportion a percentage of the wagers from the gaming device means and the non-gaming device means to the progressive jackpot;
(D) determining means for determining if a progressive jackpot-winning event has occurred; and
(E) award means for awarding the progressive jackpot, if the progressive-jackpot-winning event has occurred.

14. The gaming apparatus of claim 13, wherein the non-gaming device means are remotely located from the gaming device means.

15. The gaming apparatus of claim 13, wherein the non-gaming device means are selected from the group consisting of:
(A) computer;
(B) mobile telephone;
(C) portable music player;
(D) personal digital assistant.

16. A gaming apparatus comprising:
(A) a plurality of gaming devices;
(B) a plurality of non-gaming devices;
(C) a server in communication with the gaming devices and the non-gaming devices;
(D) software operable on the server to;
(a) allow the gaming devices to accept a first wager;
(b) apportion a first percentage of the first wager to a progressive jackpot;
(c) allow the gaming devices to play a first game;
(d) allow the gaming devices to communicate the outcome of the first game;
(e) allow the gaming devices to award a first prize;
(f) receive a request from the non-gaming devices to play a second game;
(g) credit a second wager to the non-gaming devices;
(h) apportion a second percentage of the second wager to the progressive jackpot;
(i) play a second game;
(j) communicate the outcome of the second game to the non-gaming devices;
(k) award a second prize to the non-gaming devices;
(l) determine if a progressive jackpot-winning event has occurred;
(m) communicate the occurrence of the progressive jackpot-winning event to at least one of the gaming devices or the non-gaming devices, if the progressive jackpot-winning event has occurred;
(n) award a progressive jackpot.

17. The gaming apparatus of claim 16, wherein the non-gaming devices are selected from the group consisting of:
(A) computer;
(B) mobile telephone;
(C) portable music player;
(D) personal digital assistant.

18. The gaming apparatus of claim 16, wherein the gaming devices have a higher probability of receiving the progressive jackpot.

19. The gaming apparatus of claim 16, wherein the server is in communication, with the non-gaming devices through the internet.
